(19) United States
(12) Patent Application Publication
(10) Pub. No.: US 2007/0068224 A1
(43) Pub. Date: Mar. 29, 2007

(54) Leak detection structure and fuel cartridge

(75) Inventors: Daisuke Watanabe, Ome-shi (JP); Tomohiro Hirayama, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/516,871

(22) Filed: Sep. 6, 2006

(30) Foreign Application Priority Data
Sep. 15, 2005 (JP) 2005-269037

(51) Int. Cl. G01M 3/04

(52) U.S. Cl. 73/40.7; 73/40

(57) ABSTRACT

According to one embodiment, a leak detection structure includes a storage section which contains a fluid, a sheathing member which encloses the storage section, and a detecting agent which is located between the storage section and the sheathing member and reacts with the fluid leaked from the storage section.

### CROSS-REFERENCE TO RELATED APPLICATIONS

This application is based upon and claims the benefit of priority from Japanese Patent Application No. 2005-269037, filed Sep. 15, 2005, the entire contents of which are incorporated herein by reference.

### BACKGROUND

1. Field

One embodiment of the invention relates to a leak detection structure and a fuel cartridge, for example, having a fluid leak detecting function.

2. Description of the Related Art

In recent years, small-sized, high-power fuel cell apparatuses that require no charge have come to attention as power sources for electronic devices, such as portable computers. A direct methanol fuel cell (DMFC) that uses, for example, an aqueous methanol solution as its fuel is proposed as a fuel cell apparatus of this type.

A DMFC apparatus includes a fuel cell body having an electromotive section and a fuel cartridge connected with the fuel cell body in a replaceable manner. The fuel cartridge is filled with high-concentration methanol as a fuel for power generation.

If any strong shock or vibration acts on the fuel cartridge, a part of the cartridge may be broken or cracked, in some cases. If the cartridge is broken, the fuel may possibly leak through the broken part.

Proposed as an example of the fuel cartridge is one that has a dual structure composed of a case and a fuel container housed therein. A fuel cartridge of this type is described in U.S. Pat. No. 6,808,833-B2. A fuel container of this cartridge is filled with a fuel. It is formed of a flexible material and configured to deflate inward as the fuel is supplied to a fuel cell.

Further proposed are fuel cell systems that can detect a fuel leak. One such fuel cell system is described in Jpn. Pat. Appln. KOKAI Publication No. 2004-311436, for example. In this system, an odorant is added to a fuel that is supplied to a fuel cell. If a fuel leak occurs, a user can notice it by the odor of the odorant.

Besides, there is proposed a fuel gas leak detecting coating film that can detect a leak of a fuel gas. A detecting coating film of this type is described in Jpn. Pat. Appln. KOKAI Publication No. 2000-44840, for example. This coating film is applied to the surface of a structure that handles a fuel gas. It has a pigment that changes color on contact with the fuel gas. If the fuel gas leaks, a user can notice the leak by a change of color of the detecting coating film.

In the case of the fuel cell system described in Jpn. Pat. Appln. KOKAI Publication No. 2004-311436, for example, the fuel leak is detected when the odorant in the fuel is inhaled by the user. Thus, by the time the user notices the fuel leak, the fuel is already leaked out of the fuel cell system. Many of conventionally used fuels are inflammable and harmful to the human body. Users must take care not to allow the leaked fuel to ignite and cope with the cause of the leak without carelessly touching the fuel.

Also in the case of the fuel gas leak detecting coating film described in Jpn. Pat. Appln. KOKAI Publication No. 2000-44840, the fuel gas is leaked out of the gas-handling structure by the time the user detects the gas leak by the change of color of the detecting coating film.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a fuel cartridge according to a first embodiment of the invention;

FIG. 2 is an exemplary perspective view of a DMFC apparatus according to the first embodiment;

FIG. 3 is an exemplary perspective view showing the fuel cartridge and a DMFC body according to the first embodiment;

FIG. 4 is an exemplary sectional view of the fuel cartridge according to the first embodiment;

FIG. 5 is an exemplary sectional view of a detecting agent according to the first embodiment;

FIG. 6 is an exemplary plan view showing a normal state of the detecting agents according to the first embodiment;

FIG. 7 is an exemplary plan view showing a state of the detecting agents of FIG. 4 affected by a leak;

FIG. 8 is an exemplary sectional view of a modification of the fuel cartridge according to the first embodiment;

FIG. 9 is an exemplary sectional view of a fuel cartridge according to a second embodiment of the invention;

FIG. 10 is an exemplary sectional view of a fuel cartridge according to a third embodiment of the invention;

FIG. 11 is an exemplary sectional view of a modification of the fuel cartridge according to the third embodiment;

FIG. 12 is an exemplary sectional view of another modification of the fuel cartridge according to the third embodiment;

FIG. 13 is an exemplary sectional view of still another modification of the fuel cartridge according to the third embodiment;

FIG. 14 is an exemplary perspective view of a leak detection structure according to a fourth embodiment of the invention;

FIG. 15 is an exemplary sectional view of the leak detection structure according to the fourth embodiment; and

FIG. 16 is an exemplary sectional view of a modification of the leak detection structure according to the fourth embodiment.

### DETAILED DESCRIPTION

Various embodiments according to the invention will be described hereinafter with reference to the accompanying drawings. In general, according to one embodiment of the invention, a leak detecting structure includes a storage section which contains a fluid, a sheathing member which encloses the storage section, and a detecting agent which is located between the storage section and the sheathing member and reacts with the fluid leaked from the storage section.

Embodiments of the present invention applied to a fuel cell apparatus will now be described with reference to the accompanying drawings.

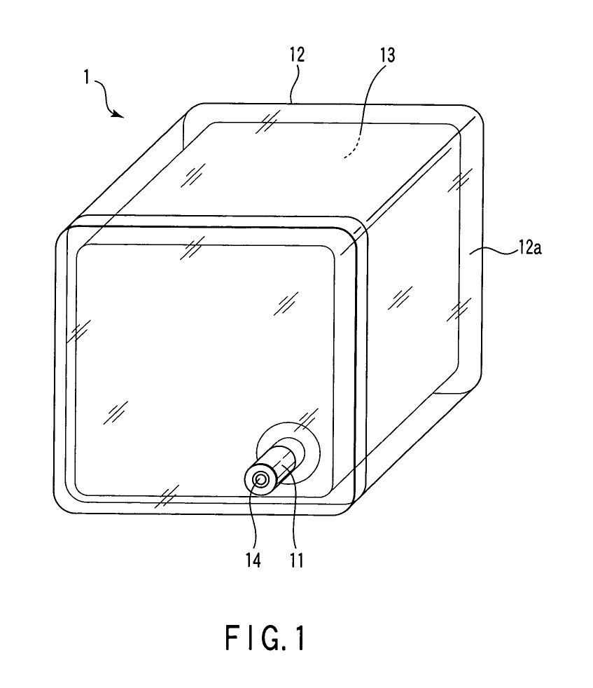

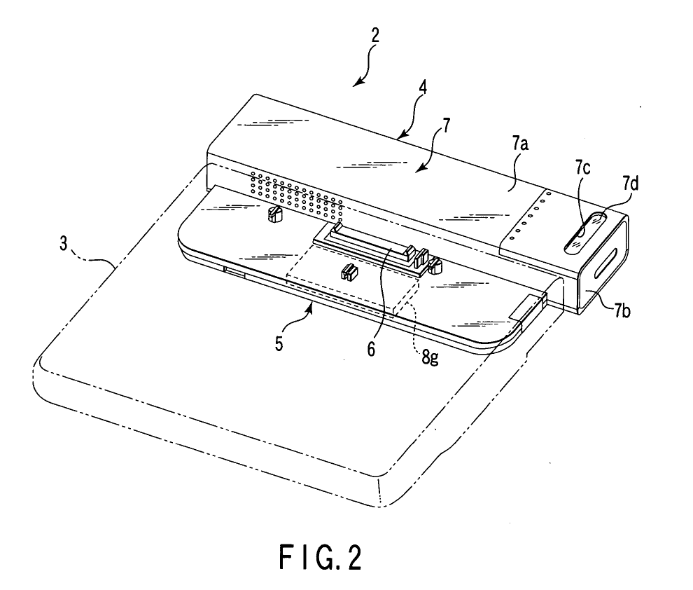

FIGS. 1 to 8 show a fuel cartridge 1 according to a first embodiment of the invention. FIG. 1 shows an outline of the cartridge 1. As shown in FIG. 2, the cartridge 1 is incorporated in a DMFC apparatus 2 when it is used. The apparatus 2 has a size such that it can be used as a power source for a portable computer 3, for example. The DMFC apparatus 2 is an example of a leak detection structure. However, the fuel cartridge 1 that is incorporated in the apparatus 2 is also an example of a leak detection structure itself.

As shown in FIG. 2, the DMFC apparatus 2 includes an apparatus body 4 and a setting section 5. The apparatus body 4 has an elongated shape extending along the longitudinal direction of the portable computer 3. The setting section 5 protrudes horizontally from the front end of the apparatus body 4 in such a manner as to be able to carry the rear end portion of the computer 3 thereon. A power supply connector 6 is located on the upper surface of the setting section 5. The connector 6 is connected electrically to the portable computer 3 when it is placed on the setting section 5.

As shown in FIG. 2, the apparatus body 4 is provided with a box-shaped housing 7. The housing 7 has an upper surface 7a, side surfaces 7b, and a lower surface (not shown). The housing 7 contains a DMFC body 8 and the fuel cartridge 1 therein. The housing 7 has a display window 7c corresponding to a region in which the cartridge 1 is housed. The display window 7c opens into the housing 7 and is covered by a see-through member 7d of, for example, resin or glass. A user of the DMFC apparatus 2 can observe the fuel cartridge 1 through the window 7c from outside the housing 7.

The location for the display window 7c is not limited to the upper surface 7a of the housing 7. For example, the window 7c may be formed in one of the side faces 7b or the lower surface. Further, the housing 7 itself may be formed of a see-through member so that the display window 7c can be omitted. The term “see-through members” described herein implies clear members in a broad sense, which include any kinds of colored, transparent, and translucent members that transmit light.

The DMFC body 8 is an example of a fuel cell unit. It performs power generation by causing a fuel L supplied from the fuel cartridge 1 to react with air introduced from outside the body 8. Generated electric power is supplied to the portable computer 3 through the power supply connector 6.

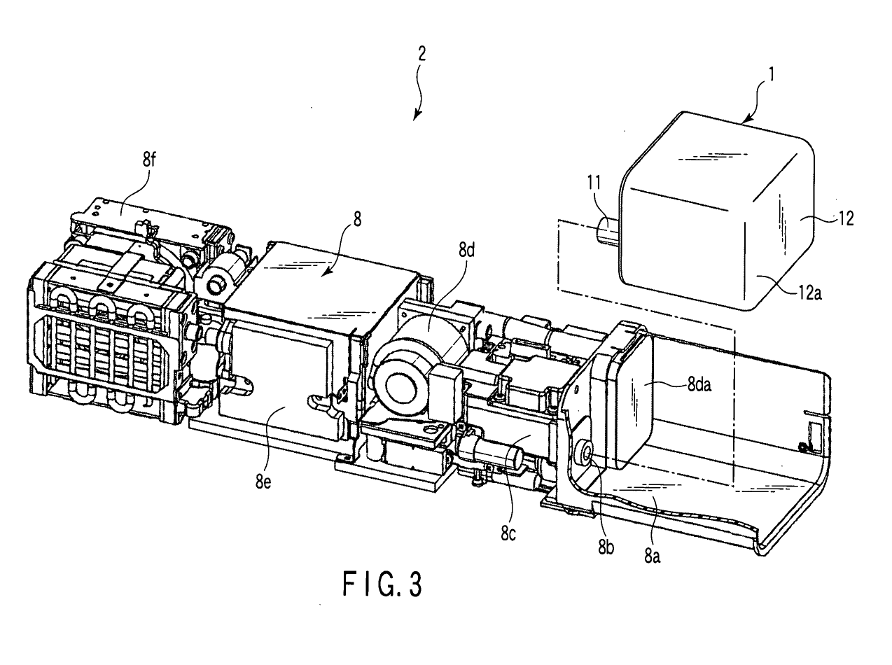

As shown in FIG. 3, the DMFC body 8 has a holder 8a on one end in its longitudinal direction. The fuel cartridge 1 is mounted in the holder 8a in a replaceable manner.

The fuel cartridge 1 contains therein high-concentration methanol as the fuel L for the power generation, for example. As shown in FIGS. 1 and 3, the cartridge 1 has a liquid feed joint 11 for feeding the fuel L to the DMFC body 8. As shown in FIG. 3, the body 8 has a fuel inlet 8b in a region corresponding to the liquid feed joint 11. When the fuel cartridge 1 is mounted in the holder 8a, the liquid feed joint 11 is connected to the fuel inlet 8b, whereupon the cartridge 1 can supply the fuel L to the DMFC body 8.

When the fuel L is exhausted, the fuel cartridge 1 is removed from the holder 8a, and a new fuel cartridge 1 is mounted in the holder 8a.

The DMFC body 8 further has a mixing section 8c, air intake section 8d, DMFC stack 8e, cooling section 8f, and control section 8g.

The mixing section 8c dilutes the high-concentration methanol supplied from the fuel cartridge 1, thereby producing an aqueous methanol solution with a concentration of several to tens of percent. The mixing section 8c feeds the produced methanol solution to the DMFC stack 8e.

As shown in FIG. 3, the air intake section 8d has an air intake port 8da that opens outside the DMFC body 8. The air intake section 8d introduces outside air into the DMFC body 8 through the air intake port 8da and feeds the introduced air into the DMFC stack 8e.

The DMFC stack 8e is an example of an electromotive section. It subjects the aqueous methanol solution and oxygen in air to a chemical reaction, thereby generating electric power. Carbon dioxide and steam are generated by this power generating operation. The generated carbon dioxide and steam and unreacted methanol are delivered to the cooling section 8f.

The cooling section 8f is located at the other end of the DMFC body 8 and serves to cool the carbon dioxide and steam generated in the DMFC stack 8e and the unreacted methanol. The cooled and liquefied water and methanol are supplied back to the mixing section 8c and used to generate an aqueous methanol solution. The generated carbon dioxide is discharged to the outside of the DMFC body 8.

As shown in FIG. 2, the control section 8g is housed in the setting section 5. It monitors the respective states of the mixing section 8c, air intake section 8d, DMFC stack 8e, and cooling section 8f and controls the operations of these units 8c, 8d, 8e and 8f. Further, the control section 8g supplies the electric power generated in the DMFC stack 8e to the power supply connector 6.

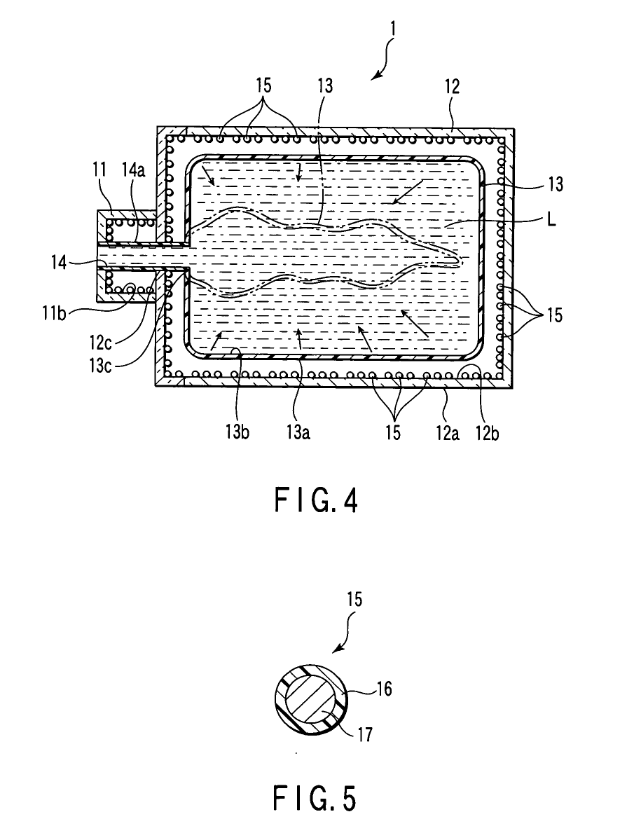

As is schematically shown in FIG. 4, the fuel cartridge 1 is provided with a case 12, inner bag 13, liquid feed pipe 14, and detecting agents 15, as well as the liquid feed joint 11.

The case 12 is an example of a sheathing member. As shown in FIGS. 1 and 4, it is in the form of a hollow box and constitutes the external shape of the fuel cartridge 1. The case 12 has an outer surface 12a and an inner surface 12b. The outer and inner surfaces 12a and 12b are exposed to the outside and inside, respectively, of the cartridge 1.

The liquid feed joint 11 protrudes from one end of the case 12. As shown in FIG. 4, the joint 11 is in the form of a hollow circular column. The case 12 has a first through hole 12c that opens in that part thereof which corresponds to the liquid feed joint 11.

The case 12 protects the inner bag 13 against shock or vibration acting from outside the fuel cartridge 1. An example of the case 12 is formed of a material that is higher in strength and shock resistance than the inner bag 13. And, one example of the case 12 is flameproof.

The case 12 and the liquid feed joint 11 are formed of the aforesaid see-through members including transparent or translucent members, for example. Thus, a user can externally observe the interior of the case 12. A resin material such as polycarbonate may be used as an example of the material of the case 12.

However, the case 12 according to the first embodiment is expected only to enable visual access to its interior from the outside, and its shape, configuration, and material may be varied freely. The case 12 may be formed entirely of a see-through member. Alternatively, only a part of its upper surface, side surface, or lower surface may be formed of a see-through member.

The inner bag 13 is an example of a storage section. As shown in FIG. 4, the inner bag 13 is one size smaller than the case 12 and housed in the case 12. In other words, the inner bag 13 is contained in the case 12. It is loaded with the aforesaid high-concentration methanol as the fuel L. The fuel L is an example of a fluid.

The inner bag 13 has an outer surface 13a and an inner surface 13b. The outer surface 13a of the bag 13 is opposed to the inner surface 12b of the case 12. The inner surface 13b of the bag 13 faces the fuel L. The inner bag 13 has a second through hole 13c that opens in that part thereof which corresponds to the liquid feed joint 11.

The fuel L is sealed in the inner bag 13. An example of the inner bag 13 is formed of a material having resistance to fuels, i.e., to methanol in the present embodiment, such that it can touch the fuel L for hours without being degraded.

One example of the inner bag 13 is formed of an elastic or flexible material. If the inner bag 13 is elastic or flexible, it deflates inward as the fuel L is supplied to the DMFC body 8, as indicated by two-dot chain line in FIG. 4. Thus, air or the like can be prevented from getting into the fuel L. Polypropylene or polyethylene may be used as an example of the material of the inner bag 13.

As shown in FIG. 4, the liquid feed pipe 14 is provided in the liquid feed joint 11. One end of the pipe 14 communicates with the inner bag 13 through the first and second through holes 12c and 13c. The other end of the pipe 14 opens to the outside of the fuel cartridge 1 at the distal end portion of the joint 11. When the cartridge 1 is not mounted in the holder 8a, the open end of the pipe 14 is sealed by a sealing mechanism (not shown).

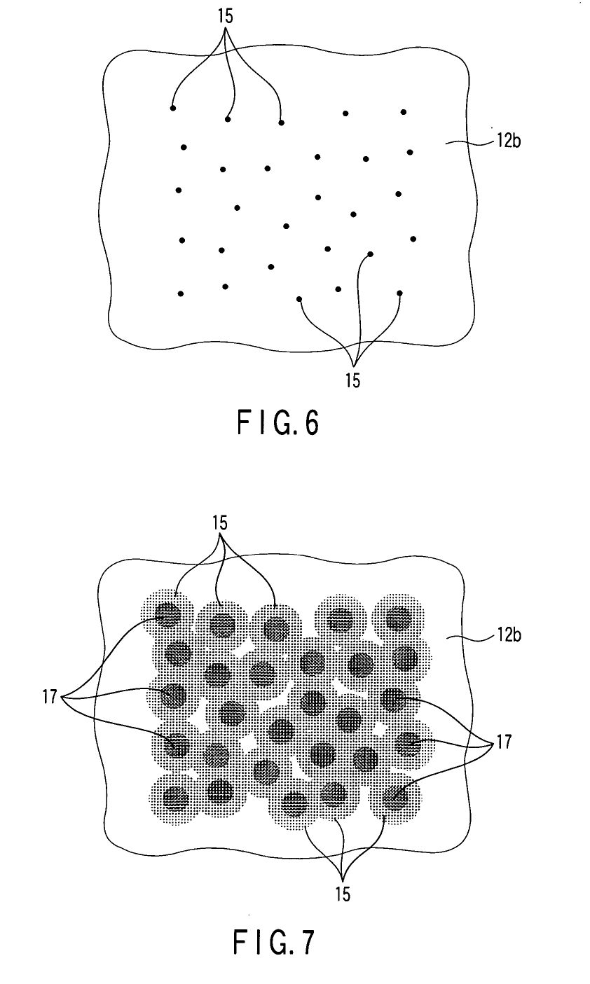

One example of each detecting agent 15 has a very small diameter of, e.g., tens of nm or less. As shown in FIG. 6, the detecting agents 15 are applied substantially uniformly to the respective inner surfaces 12b and 11b of the case 12 and the liquid feed joint 11 by, for example, spraying or the like. Thus, the detecting agents 15 are located between the case 12 and the inner bag 13.

One example of the detecting agent 15 is a leak-indicating agent that reacts with the fuel L. The detecting agents 15 react and pigment when they come into contact with the fuel L. Specifically, as shown in FIG. 5, each detecting agent 15 has a capsule 16 and an ink agent 17. The capsule 16 is formed of a material that dissolves when it touches the fuel L. An example of the capsule 16 dissolves when it comes into contact with the fuel L in a vapor phase as well as in a liquid phase. A resin material such as polyvinylalcohol that dissolves in methanol may be used as an example of the material of the capsule 16.

The ink agent 17 is contained in the capsule 16. The ink agent 17 is an example of a pigmenting agent. The “pigmenting agent” used herein implies any of substances that change from a colorless state into a colored state, change their original colors into different ones, or change from a colored state into a colorless state.

When the ink agent 17 comes into contact with the fuel L or water, it pigments by coloring the fuel or water. It pigments in, for example, red when it comes into contact with the fuel L or water. The ink agent 17 may be of any desired type, liquid or in the form of a solid body that dissolves in the fuel L, for example. An example of the ink agent 17 may be of a type such that it can be pigmented in or turned into red, orange, or some other warning color.

However, a content substance in the capsule 16 may be a chromate-based compound that turns from yellow to blue as it reacts with methanol, for example. It may be of any type that can pigment or change color when it comes into contact with the fuel L. The fuel L like methanol is in the form of an aqueous solution when it is contained in the inner bag 13. Therefore, the pigmenting agent in the capsule 16 need not be directly active to the methanol, but may be of a nature such that it pigments or changes color when it comes into contact with water. For example, the ink agent 17 pigments when it comes into contact with water.

Further, the detecting agents 15 may be applied or attached directly to the inner surface 12b of the case 12 without having the capsules 16. Each detecting agent 15 is expected only to change its state by reacting with the fuel L, and its size, structure, and type is not restricted.

The following is a description of the action of the fuel cartridge 1.

If the fuel cartridge 1 is dropped from a hand or desk, for example, by mistake before its use, that is, in a process before it is mounted in the DMFC body 8, the cartridge 1 is shocked as it hits the ground or floor. If such a shock acts on the fuel cartridge 1, the inner bag 13 may possibly undergo breakage or cracking (hereinafter referred to as breakage or the like), for example.

If the inner bag 13 undergoes breakage or the like, the fuel L leaks from it through its broken part. A “blowout” or “leak” implies a leakage of the fuel L in a vapor phase, as well as a liquid leakage of the fuel.

The inner bag 13 is enclosed by the case 12. Although the fuel L leaked from the bag 13 reaches the inner surface 12b of the case 12, therefore, it is prevented from leaking out of the fuel cartridge 1 by the wall of the case 12.

As shown in FIG. 6, the detecting agents 15 are spread on the inner surface 12b of the case 12. When the fuel L leaked from the inner bag 13 reaches the inner surface 12b of the case 12, the capsule 16 of each detecting agent 15 that comes into contact with the fuel L dissolves. If the capsule 16 dissolves, the ink agent 17 is exposed to the outside of the capsule 16 and comes into contact with the fuel L, whereupon it pigments in red, for example. As shown in FIG. 7, the detecting agents 15 pigment to call the user's attention to the possibility of a leak. The user can see how the detecting agents 15 pigment through the see-through case 12. The user can refrain from use of the fuel cartridge 1 by recognizing the pigmented detecting agents 15.

This is the case with breakage or the like of the inner bag 13 that is caused by an external shock with the fuel cartridge 1 in the DMFC apparatus 2. More specifically, the fuel L leaked from the inner bag 13 is prevented from leaking out of the cartridge 1 by the case 12. The detecting agents 15 pigment when they come into contact with the fuel L.

The user can check the state of the detecting agents 15 through the see-through case 12 and the display window 7c of the housing 7. Having thus recognized the pigmented detecting agents 15, the user can avoid danger by taking a given measure. The given measure implies an action such as stopping the operation of the DMFC apparatus 2, removing the fuel cartridge 1 from the holder 8a and putting into a sealed container, or ventilation.

According to the fuel cartridge 1 constructed in this manner, the user can be safe against the leak of the fuel L, and the leak can be detected. Specifically, the fuel cartridge 1 according to the present embodiment has the detecting agents 15. Thus, if the fuel L leaks from the inner bag 13, the detecting agents 15 pigment or do some other thing so that the leak is detected at once.

Further, the fuel cartridge 1 has the case 12 that encloses the inner bag 13. Thus, even if the fuel L leaks from the bag 13, it can be prevented from leaking out of the cartridge 1 by the case 12.

The user can recognize a leak of the fuel L before it spreads to the outside of the fuel cartridge 1, that is, before the possibility of the user directly touching the fuel increases.

If the leak of the fuel L is detected with the fuel cartridge 1 connected to the DMFC body 8, for example, the user can disengage the cartridge 1 without touching the fuel L. As the leak of the fuel L is thus detected to prevent the fuel from leaking out of the cartridge 1, the user can be safe as he/she replaces the cartridge 1 with a new one.

The “safety of the user” implies the possibility of avoiding a direct danger such that the user touches the leaked fuel L and/or of preventing the user from being exposed to an indirect danger such that the leaked fuel adheres to some other device.

If the case 12 is formed of a material that is higher in strength than the inner bag 13, there is little possibility that breakage or the like, if any, of the bag 13 will involve simultaneous breakage of the case 12 such that the fuel L leaked out of the bag 13 will leak directly from the case 12. In other words, if the strength of the inner bag 13 is lower than that of the case 12, the bag 13 can be broken first when it is shocked.

Since at least a part of the case 12 is formed of a see-through member, the state of the detecting agents 15 in the case 12 can be observed from outside the case 12. Thus, the pigmenting agent can be used for each detecting agent 15. Since the pigmenting agent is used for each detecting agent 15, moreover, the user can recognize any change of the detecting agents 15 even though the case 12 is gastight. If the case 12 is gastight, then the possibility of the vaporized fuel L leaking out of the case 12 will be reduced.

If a pigmenting agent that reacts with water is contained in each capsule 16 that dissolves in methanol, however, each detecting agent 15 can be made harmless to the human body. More specifically, many pigmenting agents that pigment or change color when affected by water are nontoxic to the human body. Thus, the conventional ink agent 17 may be used as the pigmenting agent.

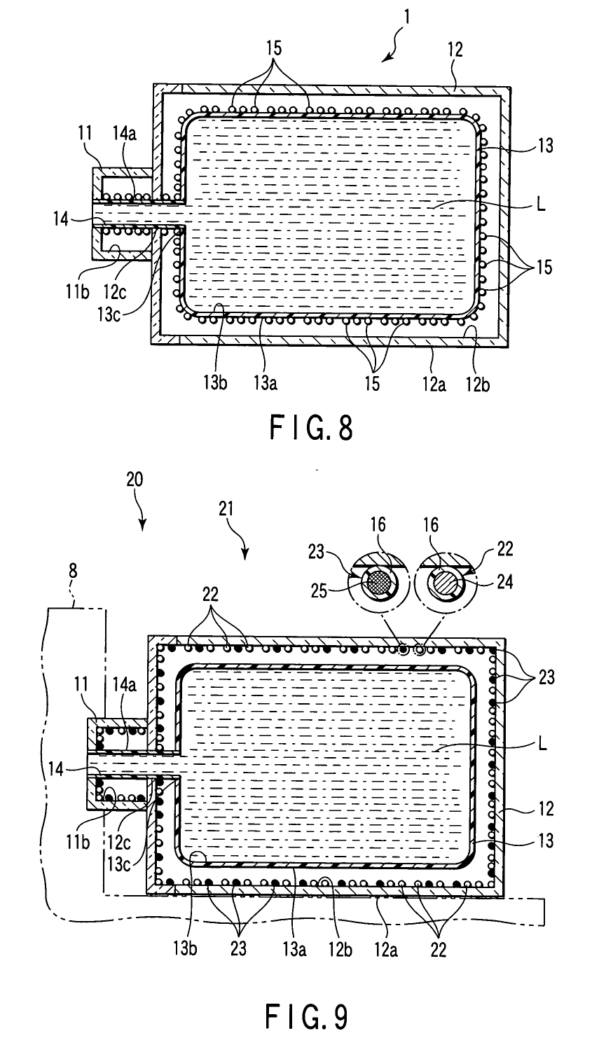

As shown in FIG. 8, the detecting agents 15 may be located on the outer surface 13a of the inner bag 13 and an outer surface 14a of the liquid feed pipe 14. Further, the detecting agents 15 may be located on both the inner surface 12b of the case 12 and the outer surface 13a of the inner bag 13.

A fuel cartridge 21 according to a second embodiment of the present invention will now be described with reference to FIG. 9. Like reference numerals are used to designate like portions that have the same functions as those of the fuel cartridge 1 and the DMFC apparatus 2 according to the first embodiment, and a description of those portions is omitted.

The fuel cartridge 21 is incorporated in a DMFC apparatus 20 when it is used. The apparatus 20 is an example of a leak detection structure. A housing 7 of the DMFC apparatus 20 contains a DMFC body 8 and the fuel cartridge 21 therein. The fuel cartridge 21 that is incorporated in the apparatus 20 is also an example of a leak detection structure itself.

The fuel cartridge 21 has first detecting agents 22 and second detecting agents 23. As shown in FIG. 9, the first and second detecting agents 22 and 23 are applied substantially uniformly to the inner surface 12b of the case 12 and an inner surface 11b of a liquid feed joint 11. Each first detecting agent 22 has a capsule 16 and a first substance 24 contained therein. Each second detecting agent 23 has a capsule 16 and a second substance 25 contained therein. The first and second substances 24 and 25 are examples of the pigmenting agent.

Each of the first and second substances 24 and 25 is a colorless simple structure that is not directly active to the fuel L or water. The substances 24 and 25 undergo a chemical reaction and pigment or change color as they are mixed with one another. Each first substance 24 and each second substance 25 may be formed in such a manner that either or both of them pigment or change color when they are mixed with each other.

The first and second detecting agents 22 and 23, like the detecting agents of the fuel cartridge 1 of the first embodiment, may be applied to an outer surface 13a of an inner bag 13.

According to the fuel cartridge 21 constructed in this manner, the user can be safe against the leak of the fuel L, and the leak can be detected. Specifically, the fuel cartridge 21 according to the present embodiment has the first and second detecting agents 22 and 23. If the fuel L leaks from the inner bag 13, the respective capsules 16 of the detecting agents 22 and 23 touch the fuel and dissolve, whereupon the first and second substances 24 and 25 are exposed to the outside of the capsules 16. As the substances 24 and 25 come into contact with one another, they undergo a chemical reaction and pigment or change color. The user can notice the leak by observing the state of the detecting agents 22 and 23.

Further, the fuel L leaked from the inner bag 13 is prevented from leaking out of the fuel cartridge 21 by the case 12.

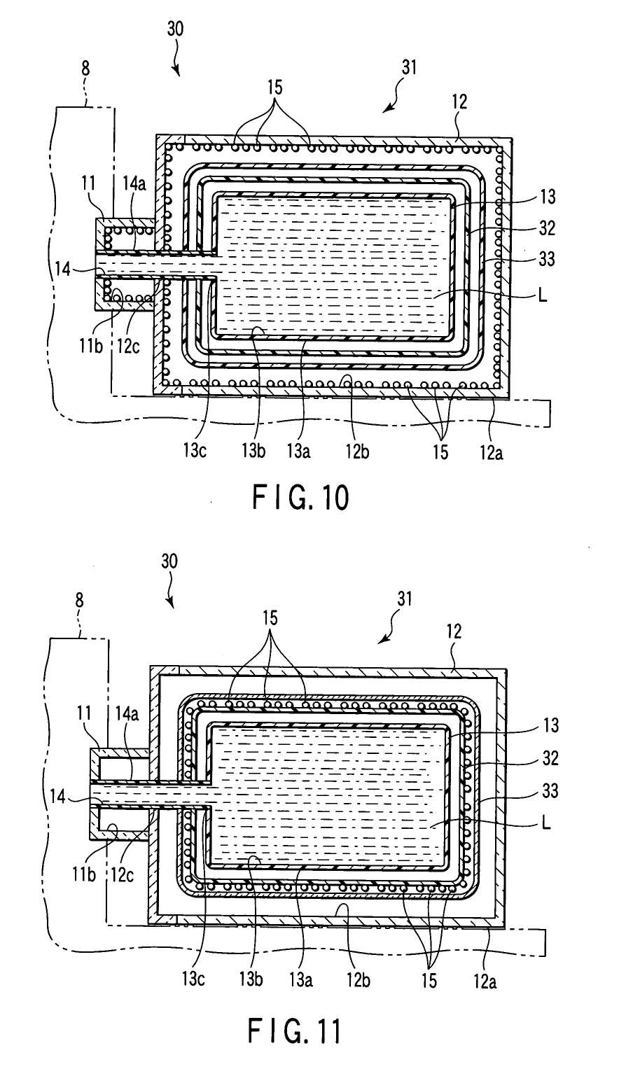

A fuel cartridge 31 according to a third embodiment of the present invention will now be described with reference to FIGS. 10 to 13. Like reference numerals are used to designate like portions that have the same functions as those of the fuel cartridges 1 and 21 and the DMFC apparatuses 2 and 20 according to the first and second embodiments, and a description of those portions is omitted.

The fuel cartridge 31 is incorporated in a DMFC apparatus 30 when it is used. The apparatus 30 is an example of a leak detection structure. A housing 7 of the DMFC apparatus 30 contains a DMFC body 8 and the fuel cartridge 31 therein. The fuel cartridge 31 that is incorporated in the apparatus 30 is also an example of a leak detection structure itself.

As shown in FIG. 10, a case 12 of the fuel cartridge 31 houses an inner bag 13 (hereinafter referred to as the first inner bag 13 for the sake of discrimination), a second inner bag 32, and a third inner bag 33. Each of the second and third inner bags 32 and 33 is an example of another inner bag.

The second and third inner bags 32 and 33 are examples of intermediate members. The second inner bag 32 encloses the first inner bag 13, while the third inner bag 33 encloses the second inner bag 32. Thus, the second and third inner bags 32 and 33 are interposed between the case 12 and the first inner bag 13. In this manner, the fuel L is enclosed by three layers, that is, the first, second, and third inner bags 13, 32 and 33.

The second and third inner bags 32 and 33 are formed of a material that is little permeable to the fuel L. Polypropylene or polyethylene may be used as an example of the material of the inner bags 32 and 33. The inner bags 32 and 33 need be neither elastic nor flexible. Therefore, they can be made thicker than the first inner bag 13 so that they are little permeable to the fuel L.

The intermediate members are not limited to two in number but may be one or three or more, for example.

Detecting agents 15 are located between the case 12 and the third inner bag 33.

According to the fuel cartridge 31 constructed in this manner, the user can be safe against the leak of the fuel L, and the leak can be detected. Specifically, the fuel cartridge 31 according to the present embodiment has the detecting agents 15. If the fuel L leaks out of the third inner bag 33, the detecting agents 15 detect the leak. The user can notice the leak by observing the state of the detecting agents 15.

Further, the leaked fuel L is prevented from leaking out of the fuel cartridge 31 by the case 12.

The fuel cartridge 31 has the second and third inner bags 32 and 33. Although the first inner bag 13 is formed of a material that is resistant to methanol, it sometimes may partially corrode when in contact with methanol for hours. In some cases, some of vaporized methanol may leak from the corroded portion, although liquid methanol may not.

Since the fuel cartridge 31 has the second and third inner bags 32 and 33, however, the leaked methanol can be prevented from reaching a region near the inner surface 12b of the case 12.

As shown in FIG. 11, at least a part of the third inner bag 33 may be formed of a light transmitting material with the detecting agents 15 located between the second and third inner bags 32 and 33. If the detecting agents 15 are located in this manner, a leak, if any, of the fuel L from the second inner bag 32 can be detected at once.

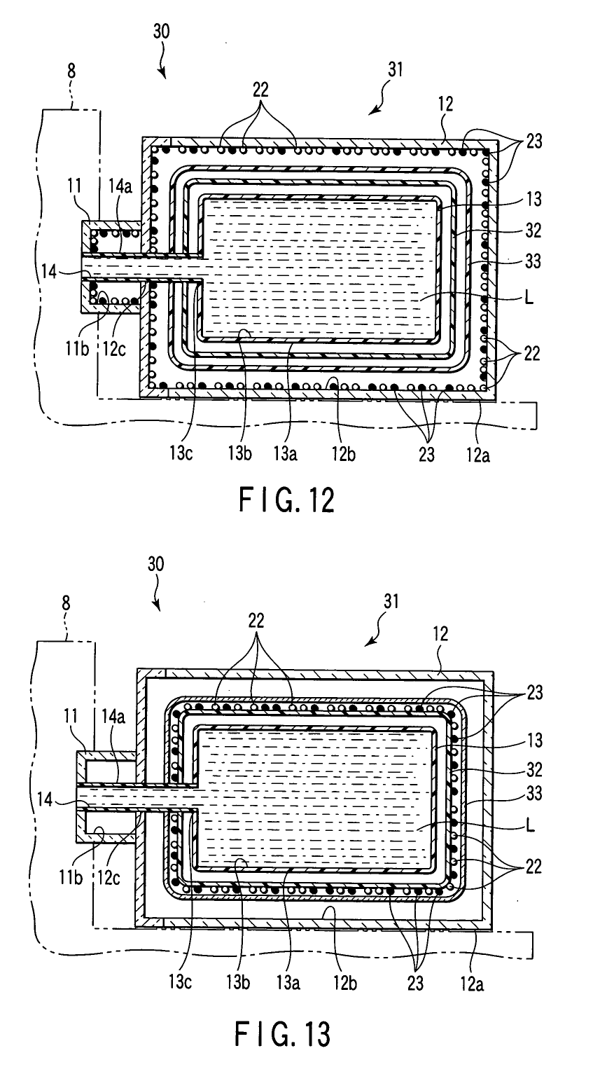

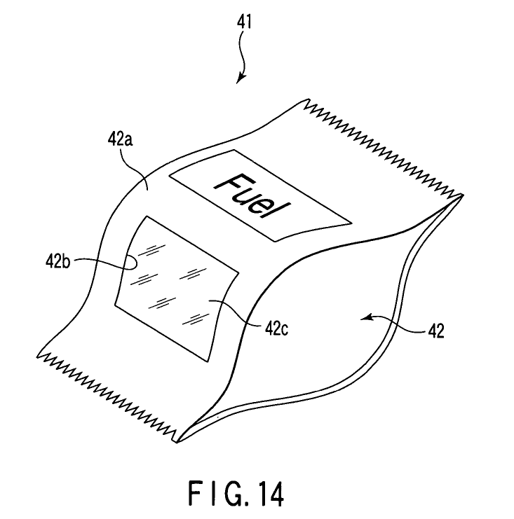

The location for the detecting agents 15 is not limited to any specific place, but they may alternatively be located between the first and second inner bags 13 and 32. If the detecting agents 15 are located between the outermost possible pair of inner bags, the user can be facilitated to observe the state of the detecting agents 15 from outside the case 12. If the fuel cartridge 31 has the first and second detecting agents 22 and 23 in place of the detecting agents 15, as shown in FIGS. 12 and 13, the user can be safe, and the leak can be detected.

A leak detection structure 41 according to a fourth embodiment of the present invention will now be described with reference to FIGS. 14 to 16. Like reference numerals are used to designate like portions that have the same functions as those of the fuel cartridges 1, 21 and 31 according to the first, second, and third embodiments, and a description of those portions is omitted.

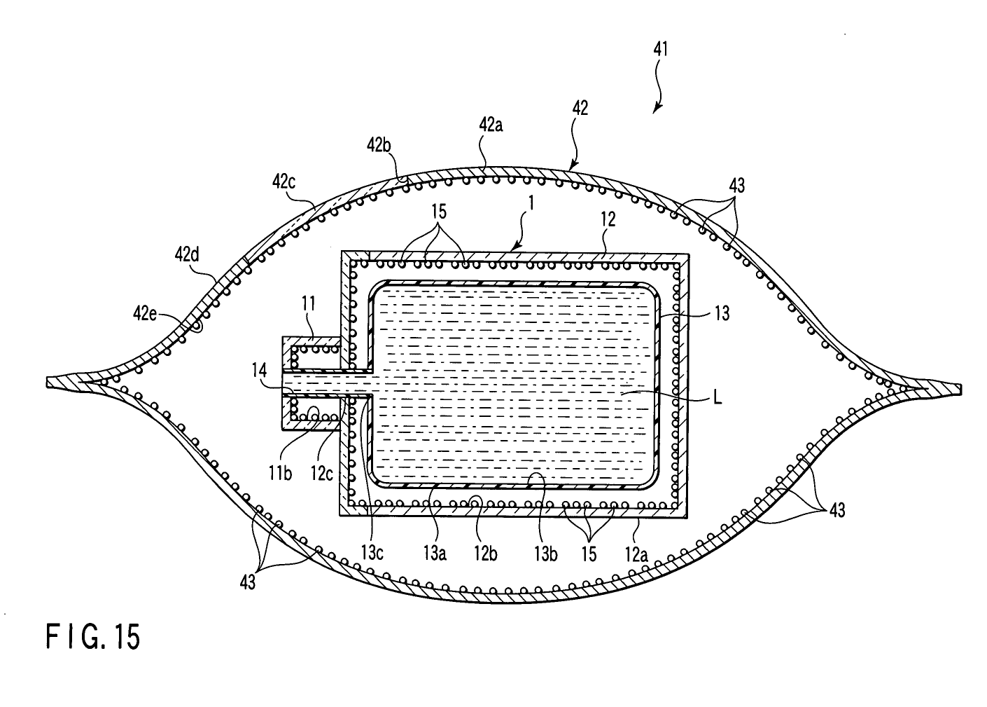

FIG. 14 shows an outline of the leak detection structure 41. As shown in FIG. 15, the leak detection structure 41 has a package 42, a fuel cartridge 1, and detecting agents 43.

The package 42 is an example of a packaging container. The package 42 houses the fuel cartridge 1. The cartridge 1 is packed in the package 42 as it is distributed among consumers. The package 42 has an outer wall 42a. The outer wall 42a is formed of a thin, flexible aluminum sheet, for example.

The outer wall 42a serves to seal and isolate the interior of the package 42 from outside light. It has a window 42b that opens to the inside of the wall 42a. The window 42b is covered by a see-through member 42c of, for example, resin or glass. The user can observe the interior of the package 42 through the window 42b. The package 42 has an outer surface 42d and an inner surface 42e.

The package 42 may be of any type that can house the fuel cartridge 1. For example, it may be formed of vinyl or the like. Further, the outer wall 42a itself may be formed of a see-through member without providing the outer wall 42a with the window 41b.

Each detecting agent 43 is an example of a pigmenting agent. As shown in FIG. 15, the detecting agents 43 are applied substantially uniformly to the inner surface 42e of the outer wall 42a. Thus, the detecting agents 43 are located between the outer wall 42a of the package 42 and the fuel cartridge 1. They are detecting agents that react with the fuel L. Each detecting agent 43, like each detecting agent 15 according to the first embodiment, has a capsule 16 and an ink agent 17.

The following is a description of the action of the leak detection structure 41.

A leak of the fuel L from the fuel cartridge 1 is most apprehended when the cartridge is in the distribution stage. If any external shock or vibration acts on the cartridge 1 to break both its inner bag 13 and case 12 in the distribution stage, the fuel L in the cartridge 1 leaks out of it through its broken part or the like. The fuel cartridge 1 is enclosed by the package 42. Although the fuel L leaked from the cartridge 1 reaches the inner surface 42e of the package 42, therefore, it is prevented from leaking out of the package 42.

As shown in FIG. 15, the detecting agents 43 are spread on the inner surface 42e of the package 42. When the fuel L leaks out of the fuel cartridge 1, therefore, the detecting agents 43 pigment to call the user's attention. By checking the state of the detecting agents 43 through the window 42b before the package 42 is unsealed, the user can check the package 42 for leakage before the package is opened. If the user recognizes the pigmented detecting agents 43, he/she can refrain from unsealing the package 42.

According to the leak detection structure 41 constructed in this manner, the user can be safe against the leak of the fuel L, and the leak can be detected. Specifically, the leak detection structure 41 according to the present embodiment has the detecting agents 43. If the fuel L leaks out of the fuel cartridge 1, the detecting agents 43 detect the leak. The user can notice the leak by observing the state of the detecting agents 43 before the package 42 is unsealed.

Further, the leaked fuel L is prevented from leaking out of the leak detection structure 41 by the package 42, whereby the user can be safe.

An additional effect can be obtained if the fuel cartridge 1 that is housed in the package 42 has the detecting agents 15 therein, as in the present embodiment. If the fuel L leaks from the inner bag 13 of the cartridge 1, the detecting agents 15 pigment. The user can observe the interior of the cartridge 1 through the window 42b of the package 42 and the case 12 before the package 42 is unsealed. Although the fuel L is not leaked out of the fuel cartridge 1 yet, therefore, the user can recognize that the leak is caused in cartridge 1 and refrain from unsealing the package 42.

The package 42 can be made a sealed container by using a light transmitting member to form at least a part of the package 42 and using the pigmenting agent for each detecting agent 43. Since the package 42 is a sealed container, the fuel cartridge 1 can be protected against external moisture, and the fuel L that is vaporized by the leak can be made less liable to leak out of the package 42.

The fuel cartridge 1 that is housed in the package 42 may be either an existing fuel cartridge that has no detecting agents 15 or the fuel cartridge 21 or 31 according to the second or third embodiment, that is, it may be of any type. The member that is housed in the package 42 is not limited to the fuel cartridge, but may be any other unit that contains a fluid.

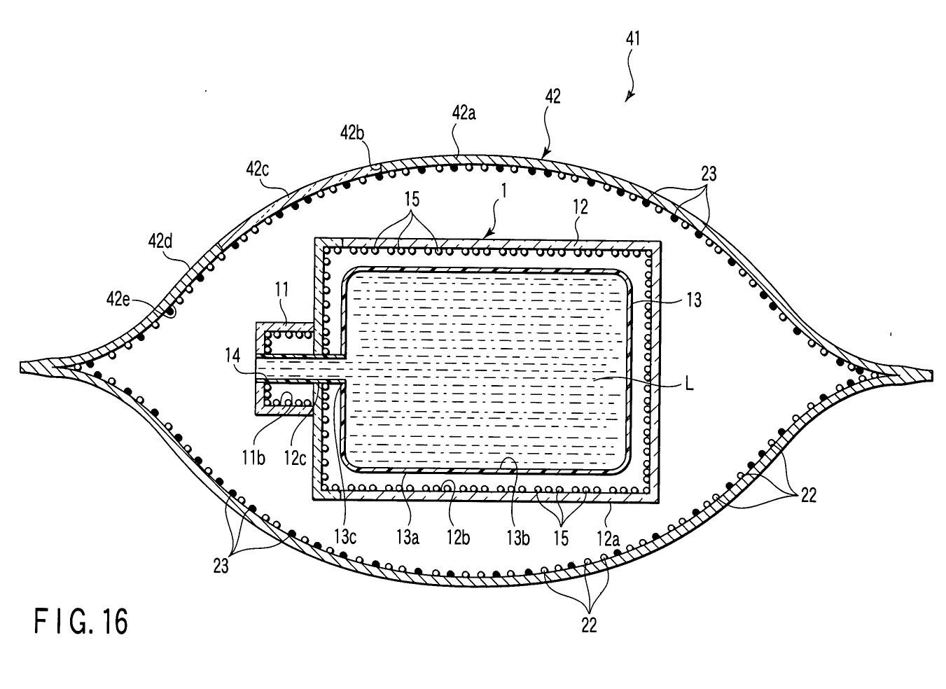

If the leak detection structure 41 is provided with the first and second detecting agents 22 and 23 in place of the detecting agents 43, as shown in FIG. 16, the user can be safe against the leak of the fuel L, and the leak can be detected.

Although the DMFC apparatuses 2, 20 and 30 and the fuel cartridges 1, 21 and 31 according to the first to third embodiments and the leak detection structure 41 according to the fourth embodiment have been described herein, it is to be understood that the present invention is not limited to these embodiments. For example, the fuel L that fills the fuel cartridge is not limited to methanol, and the embodiments of the invention may be also applied to ethanol or any other fuels than alcohol. The detecting agents 15 and 43 are not limited to pigment agents but may be formed of a substance of any type that can inform the user of a leak by reacting with the fuel or water. Further, the embodiments of the invention may be also applied to detection of a leak from any other fluid container than the fuel cell apparatus.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A leak detection structure comprising:
a storage section which contains a fluid;
a sheathing member which encloses the storage section; and
a detecting agent which is located between the storage section and the sheathing member and reacts with the fluid leaked from the storage section.

2. A leak detection structure according to claim 1, wherein the sheathing member is stronger in strength than the storage section.

3. A leak detection structure according to claim 1, further comprising an intermediate member which is housed in the sheathing member and encloses the storage section, wherein the detecting agent is located between the storage section and the intermediate member.

4. A leak detection structure according to claim 1, wherein at least a part of the sheathing member transmits light, and the detecting agent pigments or changes color on coming into contact with the fluid.

5. A leak detection structure according to claim 4, wherein the detecting agent includes a capsule which dissolves on coming into contact with the fluid and a pigmenting agent contained in the capsule.

6. A leak detection structure according to claim 5, wherein the sheathing member is stronger in strength than the storage section.

7. A leak detection structure according to claim 6, further comprising an intermediate member which is housed in the sheathing member and encloses the storage section, wherein the detecting agent is located between the storage section and the intermediate member.

8. A leak detection structure according to claim 7, wherein the pigmenting agent includes an ink.

9. A fuel cartridge comprising:
an inner bag which contains a fuel and has resistance to the fuel;
a case which contains the inner bag and has strength higher than that of the inner bag; and
a detecting agent which is located between the inner bag and the case and reacts with the fuel leaked from the inner bag.

10. A fuel cartridge according to claim 9, wherein the case is formed in such a manner that at least a part thereof transmits light, and the detecting agent pigments or changes color on coming into contact with the fuel.

11. A fuel cartridge according to claim 10, wherein the detecting agent includes a capsule which dissolves on coming into contact with the fuel and a pigmenting agent contained in the capsule.

12. A fuel cartridge according to claim 11, wherein the pigmenting agent includes an ink.

13. A fuel cartridge according to claim 11, further comprising another inner bag which is contained in the case and contains the first inner bag, wherein the detecting agent is located between the two inner bags.

14. A leak detection structure comprising:
a packing container;
a fuel cartridge which is housed in the packing container and in which a fluid is sealed; and
a detecting agent which is located between the packing container and the fuel cartridge and reacts with the fluid leaked from the fuel cartridge.

15. A leak detection structure according to claim 14, wherein at least a part of the packing container transmits light, and the detecting agent pigments or changes color on coming into contact with the fluid.

16. A leak detection structure according to claim 14, wherein the fuel cartridge includes a storage section which contains the fluid, a sheathing member which encloses the storage section, and a detecting agent which is located between the storage section and the sheathing member and reacts with the fluid.
